(19) United States
(12) Patent Application Publication
(10) Pub. No.: US 2018/0126934 A1
(43) Pub. Date: May 10, 2018

(54) BUMPER REINFORCEMENT

(71) Applicant: TOYODA IRON WORKS CO., LTD., Toyota-shi, Aichi (JP)

(72) Inventors: Yoshiyuki NAGAYAMA, Toyota-shi (JP); Naoki KAMIYA, Toyota-shi (JP)

(73) Assignee: TOYODA IRON WORKS CO., LTD., Toyota-shi, Aichi (JP)

(21) Appl. No.: 15/569,030

(22) PCT Filed: Dec. 16, 2015
(86) PCT No.: PCT/JP2015/085245

§ 371 Date: Oct. 24, 2017

(30) Foreign Application Priority Data
Apr. 24, 2015 (JP) 2015-088861

(51) Int. Cl. B60R 19/18; B60R 19/04

(52) U.S. Cl. CPC B60R 19/18; B60R 2019/1826; B60R 19/04

(57) ABSTRACT

Embodiments include a bumper reinforcement having a length including a first section and a second section. The reinforcement includes a reinforcement body made of a steel sheet and having a cross section that is open on one side and uniform along the length of the bumper reinforcement, the cross section of the body in at least the first section of the reinforcement including a high-strength portion and a low-strength portion, the high-strength portion having a first tensile strength, and the low-strength portion having a second tensile strength that is less than the first tensile strength. In an embodiment, the reinforcement further includes a closure closing the open side of the body within the first section of the reinforcement and joined to the body at the low-strength portion in the first section.

### FIELD OF THE INVENTION

The present invention relates to bumper reinforcements that ensure safety in the event of vehicle collisions.

### DESCRIPTION OF THE RELATED ART

High tensile steel sheets have been conventionally used in bumper reinforcements in order to ensure safety in the event of vehicle collisions. Hot stamping has been used to form high tensile steel sheets into bumper reinforcements in order to achieve high dimensional accuracy.

Bumper reinforcements manufactured by hot stamping high tensile steel sheets whose tensile strength after quenching is 1,800 MPa or more may lead to cracks and a significantly reduced peak load in the event of a collision due to their extremely low stretch ratio.

One way to prevent cracks in the event of a collision is the method of manufacturing a bumper reinforcement member disclosed in Japanese Patent No. 5137323. This method is for manufacturing a bumper reinforcement member whose end sections are bent with respect to its relatively straight middle section, and which is attached to the vehicle body structure at locations between the bends and the ends, the bumper reinforcement having a uniform cross section along its length. In this method, a metal sheet of a high tensile steel is heated and then quenched while being formed between dies. This method is characterized in that the metal sheet is spaced 110 to 500% of its thickness from the dies in the areas that form the bent portions of the bumper reinforcement member to make a reduced strength portions, which comprises a soft ferrite and pearlite structure or bainitic structure with hardness of 334 to 410 HV, in the bent portion of the bumper reinforcement member.

### SUMMARY OF THE INVENTION

However, the bumper reinforcement with a reduced strength portion formed by the manufacturing method above is locally deformed in the reduced strength portion due to the extremely low cross-sectional strength of the reduced strength portion. Accordingly, cracks will not occur in the event of a collision, but the reduced strength portion is plastically deformed prior to the other portions of the bumper reinforcement, resulting in a reduced peak load.

There is a need in the art to provide a bumper reinforcement that prevents cracks and a reduced peak load in the event of a collision.

The present invention provides, in one aspect, a bumper reinforcement made of a steel sheet, the reinforcement comprising a high-strength portion having a higher tensile strength, and a low-strength portion having a lower tensile strength, and the reinforcement having a cross section that is open on one side and uniform along a length of the bumper reinforcement. The reinforcement has a first cross section and a second cross section, the first cross section comprising both the high-strength portion and the low-strength portion, and the second cross section comprising the high-strength portion and not the low-strength portion. The reinforcement further comprises yield strength increasing means for equalizing an yield strength of the first cross section of the reinforcement to that of the second cross section of the reinforcement.

In some embodiments, the yield strength increasing means comprises a closure closing the first cross section and coupled to the low-strength portion in the first cross section.

In some embodiments, the yield strength increasing means comprises a sheet member placed on and coupled to the low-strength portion in the first cross section.

In some embodiments, the yield strength increasing means comprises a thicker sheet having the first cross section and thinner sheets having the second cross section, the thicker sheet being joined between two of the thinner sheets.

In some embodiments, the yield strength increasing means comprises a bulk body placed in the first cross section and secured to the low-strength portion in the first cross section.

In some embodiments, the yield strength increasing means comprises a carbon fiber reinforced plastic member placed on and coupled to the low-strength portion in the first cross section.

In some embodiments, the bumper reinforcement does not allow the low-strength portion in the first cross section to be plastically deformed prior to the high-strength portions in the first cross section and second cross section. This may prevent cracks and a reduced peak load in the event of a collision.

In some embodiments, the bumper reinforcement includes a portion in the first cross section on which the sheet member placed, resulting in a locally larger heat capacity. This prevents elevating temperature in this portion when quenching the steel sheet, so that the low-strength portion is may be included without controlling the cooling rate.

### BRIEF DESCRIPTION OF THE DRAWINGS

FIG. 1 is a perspective view of a bumper reinforcement according to a first embodiment.

FIG. 2 is a plan view of the bumper reinforcement.

FIG. 3 is a cross-sectional view of the bumper reinforcement taken along line A-A in FIG. 2.

FIG. 4 is a cross-sectional view of the bumper reinforcement of FIG. 3, showing only the elongated body, with the elongated closure removed.

FIG. 5 is a bottom view of the bumper reinforcement.

FIG. 6 is a perspective view of a bumper reinforcement according to a second embodiment.

FIG. 7 is a plan view of the bumper reinforcement.

FIG. 8 is a cross-sectional view of the bumper reinforcement taken along line B-B in FIG. 7.

FIG. 9 is a cross-sectional view of the bumper reinforcement of FIG. 8, showing only the elongated body with the elongated sheet members removed.

FIG. 10 is a bottom view of the bumper reinforcement.

FIG. 11 is a perspective view of a bumper reinforcement according to a third embodiment.

FIG. 12 is a plan view of the bumper reinforcement.

FIG. 13 is a cross-sectional view of the bumper reinforcement taken along line C-C in FIG. 12.

FIG. 14 is a cross-sectional view of the bumper reinforcement taken along line C-C in FIG. 12.

FIG. 15 is a cross-sectional view of the bumper reinforcement taken along line D-D in FIG. 12.

FIG. 16 is a cross-sectional view of the bumper reinforcement taken along line E-E in FIG. 12.

FIG. 17 is a bottom view of the bumper reinforcement.

FIG. 18 is a perspective view of a bumper reinforcement according to a fourth embodiment.

FIG. 19 is a plan view of the bumper reinforcement.

FIG. 20 is a cross-sectional view of the bumper reinforcement taken along line F-F in FIG. 19.

FIG. 21 is a cross-sectional view of the bumper reinforcement of FIG. 20, showing only the elongated body with the bulk body removed.

FIG. 22 is a bottom view of the bumper reinforcement.

FIG. 23 is a cross-sectional view of a bumper reinforcement according to a fifth embodiment, taken along a line corresponding to line B-B in FIG. 7.

FIG. 24 is a cross-sectional view of the bumper reinforcement of FIG. 23, showing only the elongated body with the carbon fiber reinforced plastic members removed.

### DETAILED DESCRIPTION OF THE INVENTION

Embodiments of the present invention will be described below in detail with reference to the drawings.

### 1. First Embodiment

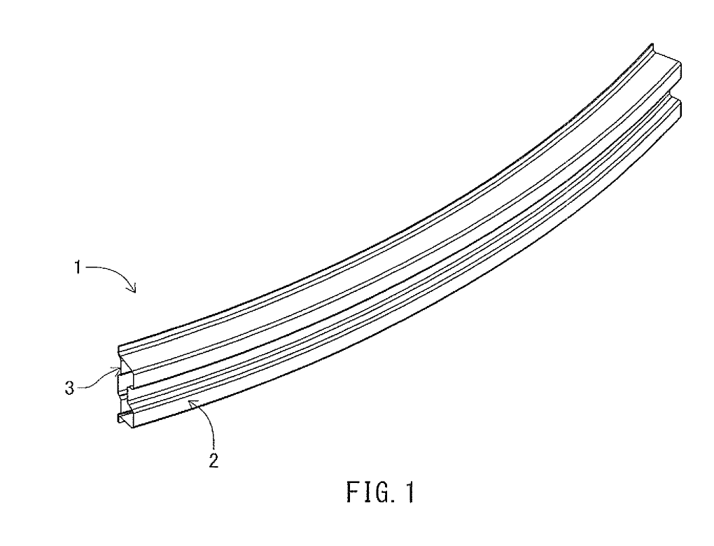

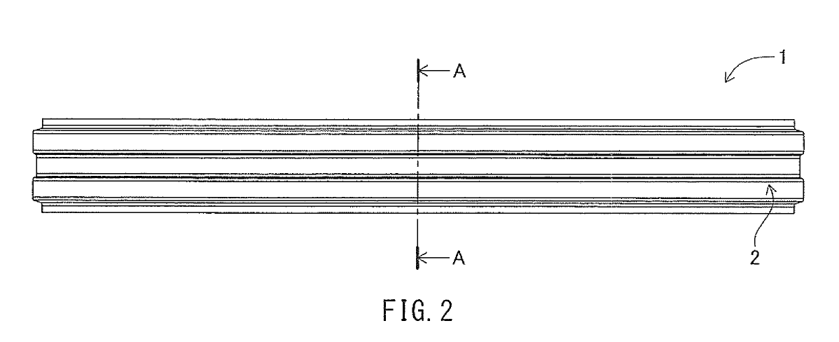

A first embodiment will be described. As shown in the perspective view in FIG. 1 and the plan view of FIG. 2, a bumper reinforcement 1 in the first embodiment has a curved profile and includes an elongated body 2 and an elongated closure 3.

The elongated body 2 is formed by hot stamping a high tensile steel sheet with a tensile strength of 1,800 MPa or more.

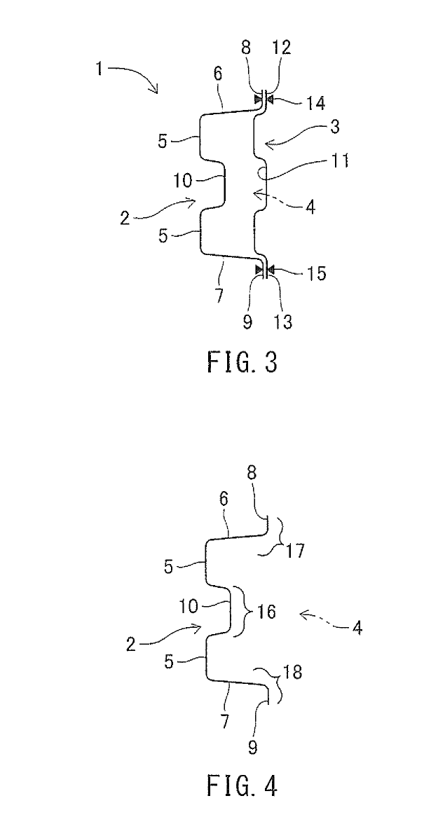

As shown in the cross-sectional view in FIG. 3, the elongated body 2 has an open rear side 4, a front wall 5 opposite the open rear side 4, a top wall 6 extending from the upper end of the front wall 5 toward the open rear side 4, a bottom wall 7 extending from the lower end of the front wall 5 toward the open rear side 4, an upper flange 8 extending upward from the end of the top wall 6 proximate the open rear side 4, and a lower flange 9 extending downward from the end of the bottom wall 7 proximate the open rear side 4. The front wall 5 includes a bead 10 along the centerline.

On the other hand, the elongated closure 3 is formed by hot stamping a high tensile steel sheet with a tensile strength of 980 MPa or less for preventing HAZ fracture during welding.

As shown in FIG. 3, the elongated closure 3 has a bead 11 along its centerline, an upper end 12 located above the bead 11, and a lower end 13 located below the bead 11.

The elongated closure 3 is joined at the upper and lower ends 12, 13 to the upper and lower flanges 8, 9 of the elongated body 2, closing the cross section of the elongated body 2. This joining is performed by spot welding at welding spots 14, 15.

In the hot stamping for the elongated body 2, the cooling rate is locally reduced or the high tensile steel sheet is locally not heated up to the A3 transformation point so that the resultant elongated body 2 has portions 16, 17, 18 that have not been quenched (hereinafter “unquenched portions”), as shown in FIG. 4.

Of the three unquenched portions 16, 17, 18, the unquenched portion 16 extends along the bead 10. The unquenched portion 17 extends from the upper flange 8 to part of the top wall 6. The unquenched portion 18 extends from the lower flange 9 to part of the bottom wall 7.

The unquenched portions 17, 18 extend in areas where the elongate body 2 tends to be strained significantly in the event of a collision, and cover the welding spots 14, 15 (see FIGS. 3 and 4), respectively.

The unquenched portions 16, 17, 18 of the elongated body 2 are low-strength portions that are softer and lower in tensile strength as they have not been quenched. All other portions of the elongated body 2 are high-strength portions that are harder and higher in tensile strength as they have been quenched.

The elongated body 2 has the cross section shown in FIG. 4 that is open on the rear side 4 and uniform along the length of the elongated body 2.

As described above, the first embodiment includes an elongated closure 3 that closes the cross section of the elongated body 2 and is spot-welded to the unquenched portions 17, 18 of the elongated body 2 so that the cross-sectional strength of the bumper reinforcement 1 shown in FIG. 3 is equalized to the cross-sectional strength that the elongated body 2 would have if the entire elongated body 2 has been quenched.

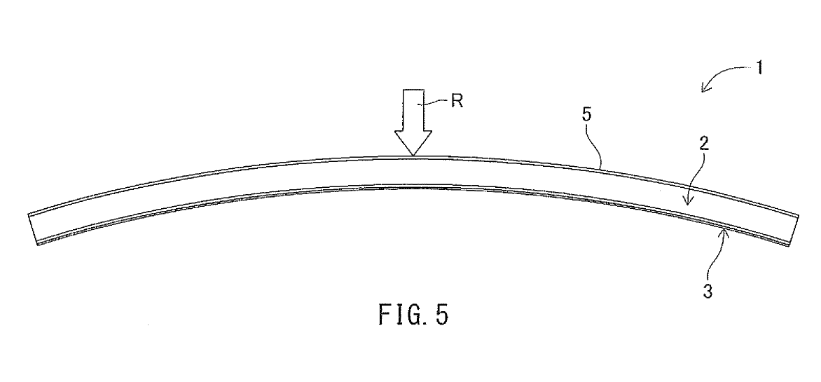

Accordingly, when an impact load R is applied to the front wall 5 of the elongated body 2 around the middle of the length as shown in FIG. 5, the bumper reinforcement 1 in the first embodiment does not allow the unquenched portions 16, 17, 18 (see FIG. 4) of the elongated body 2 to be plastically deformed prior to the quenched portions of the elongated body 2. This may prevent cracks and a reduced peak load in the event of a collision.

In the bumper reinforcement 1 in the first embodiment, the elongated closure 3, which is spot-welded to the body 2, may extend only a specified length of the elongated body 2 around the middle, which is subject to impact load R.

### 2. Second Embodiment

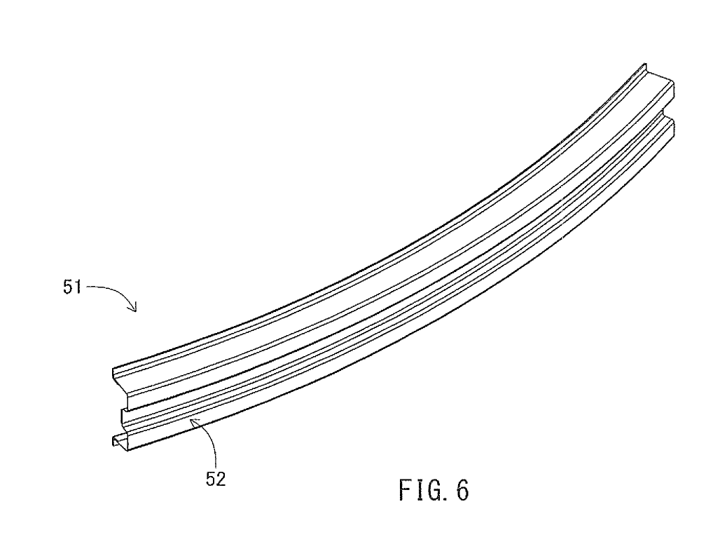

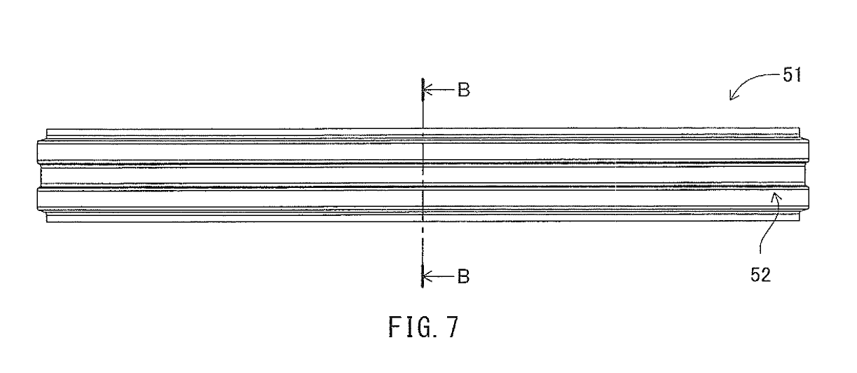

A second embodiment will now be described. As shown in the perspective view in FIG. 6 and the plan view in FIG. 7, a bumper reinforcement 51 in the second embodiment has a curved profile and includes an elongated body 52.

The elongated body 52 is formed by hot stamping a high tensile steel sheet with a tensile strength of 1,800 MPa or more.

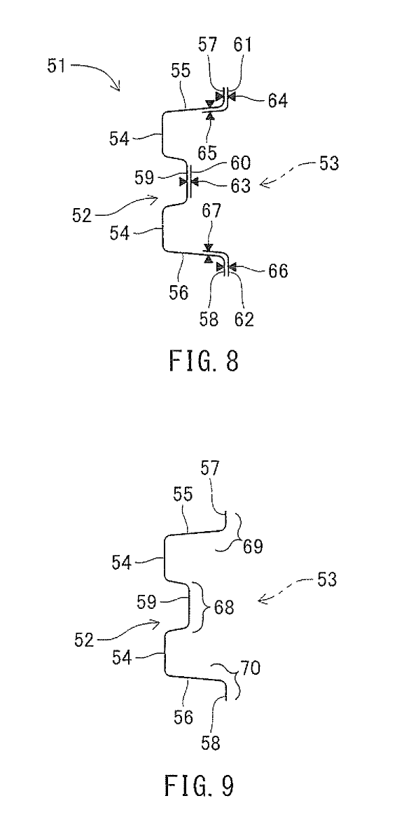

As shown in the cross-sectional view in FIG. 8, the elongated body 52 has an open rear side 53 that is open, a front wall 54 opposite the open rear side 53, a top wall 55 extending from the upper end of the front wall 54 toward the open rear side 53, a bottom wall 56 extending from the lower end of the front wall 54 toward the open rear side 53, an upper flange 57 extending upward from the end of the top wall 55 proximate the open rear side 53, and a lower flange 58 extending downward from the end of the bottom wall 56 proximate the open rear side 53. The front wall 54 includes a bead 59 is formed along the centerline.

Elongated sheet members 60, 61, 62 are placed on the elongated body 52. The elongated sheet members 60, 61 62 comprise high tensile steel sheets with a tensile strength of 1,800 MPa or more. The elongated sheet members 60, 61, 62 are spot-welded in advance to the blank to be formed into the elongated body 52 before the elongated body 52 is formed by hot stamping (hereinafter this spot welding will be referred to as “pre-spot welding”).

The elongated sheet member 60 is placed on the region of the blank that will be formed into the bead 10 of the elongated body 52, and is pre-spot-welded to the region at a welding spot 63. The elongated sheet member 61 is placed on the region of the blank that will be formed into the upper flange 57 and a part of the top wall 55 of the elongated body 52, and is pre-spot-welded to the region at welding spots 64, 65. The elongated sheet member 62 is placed on the region of the blank that will be formed into the lower flange 58 and a part of the bottom wall 56 of the elongated body 52, and is pre-spot-welded to the region at welding spots 66, 67.

The blank to be formed into the elongated body 52 locally has a larger thickness, and thus a larger heat capacity, in the elongate sheet members 60, 61, 62 and in the regions having the elongate sheet members 60, 61, 62 placed thereon. Accordingly, in the hot stamping for the elongated body 52, the blank can be locally not heated up to the A3 transformation point due to the difference in heat capacity, so that the resultant elongated body 2 has unquenched portions 68, 69, 70, as shown in FIG. 9.

Of the three unquenched portions 68, 69, 70, the unquenched portion 68 extends along the bead 59 and corresponds to the region having the elongated sheet member 60 placed thereon. The unquenched portion 69 extends from the upper flange 57 to part of the top wall 55 and corresponds to the region having the elongated sheet member 61 placed thereon. The unquenched portion 70 extends from the lower flange 58 to part of the bottom wall 56 and corresponds to the region having the elongated sheet member 62 placed thereon.

The unquenched portions 69, 70 extend in areas where the elongate body 52 tends to be strained significantly in the event of a collision, and cover the welding spots 64, 65, 66, 67 (see FIGS. 8 and 9).

The unquenched portions 68, 69, 70 of the elongated body 52 are low-strength portions that are softer and lower in tensile strength as they have not been quenched. All other portions of the elongated body 52 are high-strength portions that are harder and higher in tensile strength as they have been quenched.

The cross section of the elongated body 52 shown in FIG. 9 is open on the rear side 53 and uniform along the length of the elongated body 52.

As described above, the second embodiment includes elongated sheet members 60, 61, 62 placed on the regions of the cross section of the elongated body 52 and coupled to the unquenched portions 68, 69, 70 of the elongated body 52 so that the cross-sectional strength of the bumper reinforcement 51 shown in FIG. 8 is equalized to the cross-sectional strength the elongated body 52 would have if the entire elongated body 52 has been quenched.

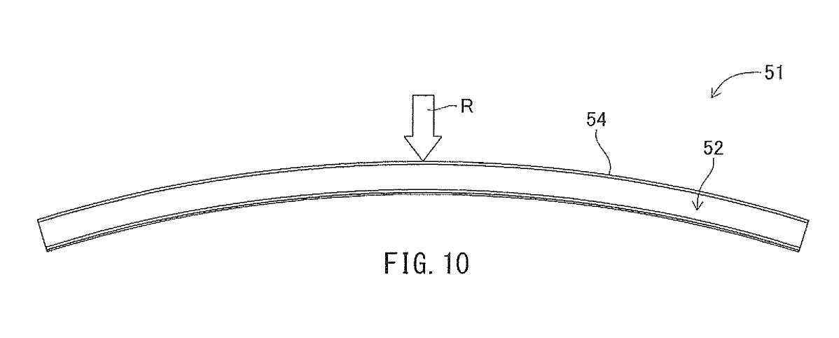

Accordingly, when an impact load R is applied to the front wall 54 of the elongated body 52 around the middle of the length as shown in FIG. 10, the bumper reinforcement 51 in the second embodiment does not allow the unquenched portions 68, 69, 70 (see FIG. 9) of the elongated body 52 to be plastically deformed prior to the quenched portions of the elongated body 52. This may prevent cracks and a reduced peak load in the event of a collision.

In the bumper reinforcement 51 in the second embodiment, the elongated sheet members 60, 61, 62, which are pre-spot-welded to the blank to be formed into the elongated body 52, may extend only a specified length of the body 52 around the middle, which is subject to impact load R.

### 3. Third Embodiment

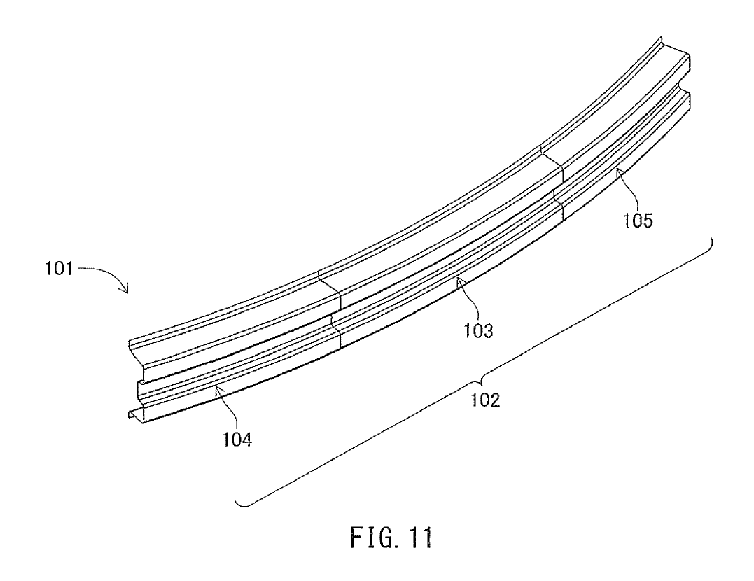

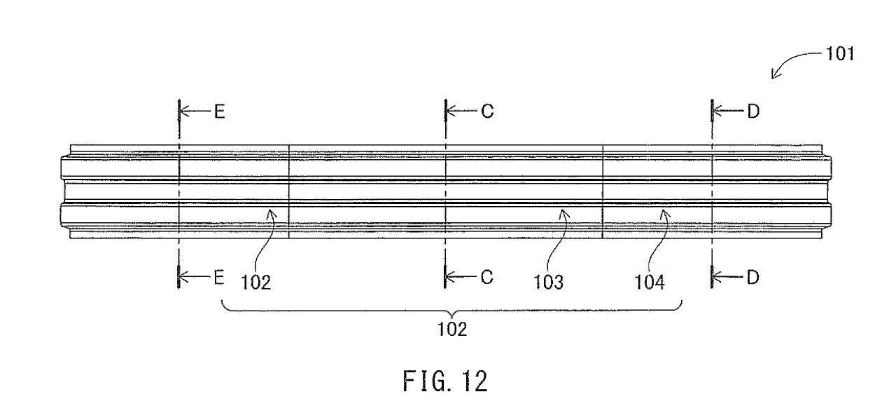

A third embodiment will now be described. As shown in the perspective view in FIG. 11 and the plan view in FIG. 12, a bumper reinforcement 101 in the third embodiment has a curved profile and includes an elongated body 102.

The elongated body 102 is made of a tailored blank comprising a thicker sheet 103 joined between two thinner sheets 104, 105. The elongated body 102 is formed by hot stamping. The thicker sheet 103 and the thinner sheets 104, 105 are high tensile steel sheets with a tensile strength of 1,800 MPa or more.

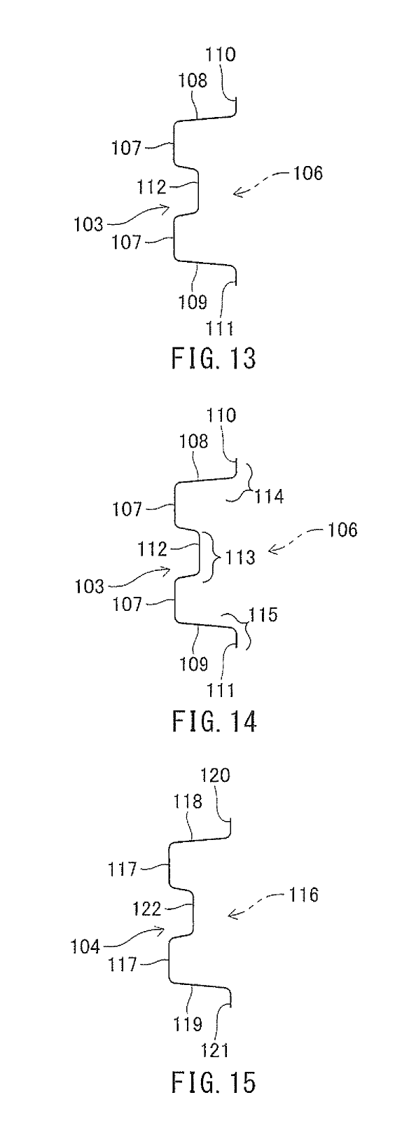

As shown in the cross-sectional view in FIG. 13, the thicker sheet section 103 has an open rear side 106, a front wall 107 opposite the open rear side 106, a top wall 108 extending from the upper end of the front wall 107 toward the open rear side 106, a bottom wall 109 extending from the lower end of the front wall 107 toward the open rear side 106, an upper flange 110 extending upward from the end of the bottom wall 108 proximate the open rear side 106, and a lower flange 111 extending downward from the end of the bottom wall 109 proximal the open rear side 106. The front wall 107 includes a bead 112 is formed along the centerline.

In the hot stamping for the thicker sheet section 103, the cooling rate is locally reduced or the tailored blank is locally not heated up to the A3 transformation point, so that the resultant thicker sheet section 103 has unquenched portions 113, 114, 115, as shown in FIG. 14.

Of the three unquenched portions 113, 114, 115, the unquenched portion 113 extends along the bead 112. The unquenched portion 114 extends from the upper flange 110 to part of the top wall 108. The unquenched portion 115 extends from the lower flange 111 to part of the bottom wall 109.

The unquenched portions 114, 115 extend in areas where the thicker sheet section 103 tend to be strained significantly in the event of a collision.

The unquenched portions 113, 114, 115 of the thicker sheet section 103 are low-strength portions that are softer and lower in tensile strength as they have not been quenched. All other portions of the thicker sheet section 103 are high-strength portions that are harder and higher in tensile strength as they have been quenched.

As shown in the cross-sectional view in FIG. 15, the thinner sheet section 104 of the body 102 has an open rear side 116 that is open, a front wall 117 opposite the open rear side 116, a top wall 118 extending from the upper end of the front wall 117 toward the open rear side 116, a bottom wall 119 extending from the lower end of the front wall 117 toward the open rear side 116, an upper flange 120 extending upward from the end of the top wall 118 proximate the open rear side 116, and a lower flange 121 extending downward from the end of the bottom wall 119 proximate the open rear side 116. The front wall 117 includes a bead 122 is formed along the centerline.

Since the thinner sheet section 104 is quenched by hot stamping, the entire thinner sheet section 104 is a high-strength portion that is harder and higher in tensile strength.

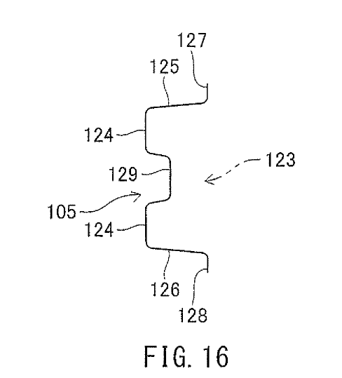

As shown in the cross-sectional view in FIG. 16, the thinner sheet section 105 of the body 102 has an open rear side 123 that is open, a front wall 124 opposite the open rear side 123, a top wall 125 extending from the upper end of the front wall 124 toward the open rear side 123, a bottom wall 126 extending from the lower end of the front wall 124 toward the open rear side 123, an upper flange 127 extending upward from the end of the top wall 125 proximate the open rear side 123, and a lower flange 128 extending downward from the end of the bottom wall 126 proximate the open rear side 123. The front wall 124 includes a bead 129 is formed along the centerline.

Since the thinner sheet section 105 is quenched by hot stamping, the entire thinner sheet section 105 is a high-strength portion that is harder and higher in tensile strength.

The cross sections of the thicker sheet section 103 and the thinner sheet sections 104, 105 shown in FIGS. 13-16 are open on the rear side 106, 116, 123, and uniform along the length of the elongated body 102.

As described above, the third embodiment includes the thicker sheet section 103 with a cross section as shown in FIGS. 13 and 14 comprising the unquenched portions 113, 114, 115 and the quenched portions, and the thinner sheet sections 104, 105 with cross sections as shown in FIGS. 15 and 16 that have been entirely quenched so that the cross-sectional strength of the thicker sheet section 103 is equalized to the cross-sectional strength of the thinner sheet sections 104, 105.

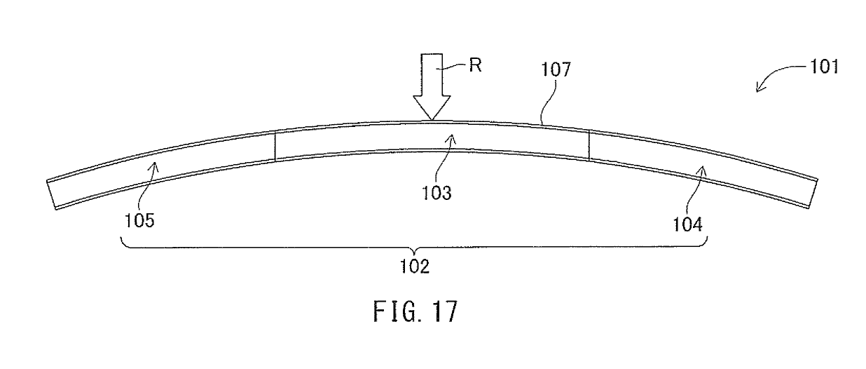

Accordingly, when an impact load R is applied to the thicker sheet section 103 on the front wall 107 around the middle of the length of the elongated body 102 as shown in FIG. 17, the bumper reinforcement 101 in the third embodiment does not allow the unquenched portions 113, 114, 115 (see FIG. 14) of the thicker sheet section 103 to be plastically deformed prior to the quenched portions of the thicker sheet section 103. This may prevent cracks and a reduced peak load in the event of a collision.

### 4. Fourth Embodiment

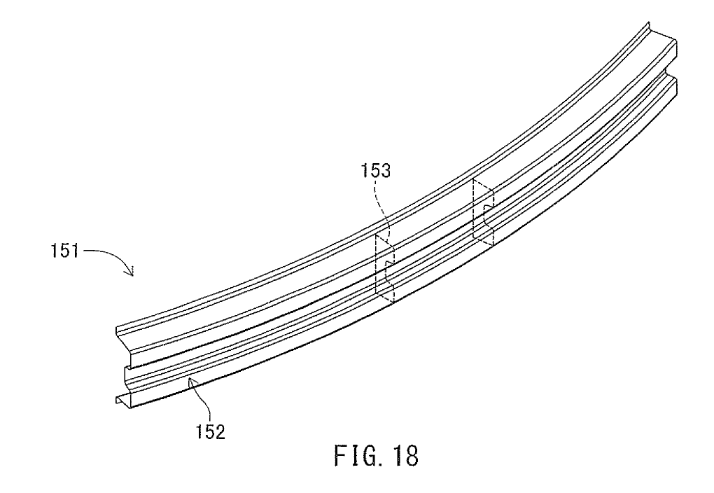

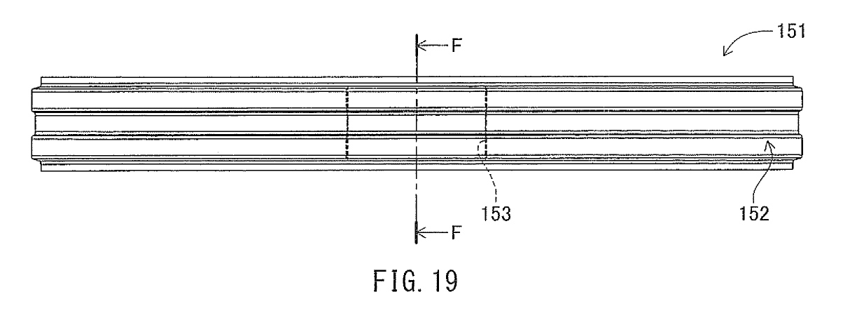

A fourth embodiment will now be described. As shown in the perspective view in FIG. 18 and the plan view of FIG. 19, a bumper reinforcement 151 in the fourth embodiment has a curved profile and includes an elongated body 152 and a bulk body 153 placed in a length of the elongated body 152 around the middle of the elongated body 152.

The elongated body 152 is formed by hot stamping a high tensile steel sheet with a tensile strength of 1,800 MPa or more.

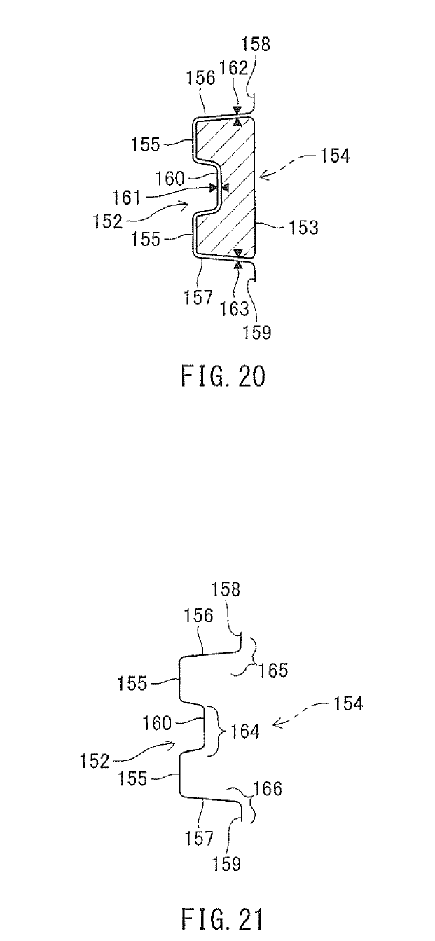

As shown in the cross-sectional view in FIG. 20, the elongated body 152 has an open rear side 154, a front wall 155 opposite the open rear side 154, a top wall 156 extending from the upper end of the front wall 155 toward the open rear side 154, a bottom wall 157 extending from the lower end of the front wall 155 toward the open rear side 154, an upper flange 158 extending upward from the end of the top wall 156 proximate the open rear side 154, and a lower flange 159 extending downward from the end of the bottom wall 157 proximate the open rear side 154. The front wall 155 includes a bead 160 is formed along the centerline.

On the other hand, the bulk body 153 may comprise iron powder pressed into the form and have a tensile strength of 590 MPa. As shown in FIG. 20, the bulk body 153 fills the cross section of the elongated body 152, and is secured to the bead 160, top wall 156, and bottom wall 157 of the elongated body 152. This securement is performed by arc welding at welding spots 161, 162, 163.

In the hot stamping for the elongated body 152, the cooling rate is locally reduced or the high tensile steel sheet is locally not heated up to the A3 transformation point, so that the resultant elongated body 152 has unquenched portions 164, 165, 166, as shown in FIG. 21.

Of the three unquenched portions 164, 165, 166, the unquenched portion 164 extends along the bead 160. The unquenched portion 165 extends from the upper flange 158 to part of the top wall 156. The unquenched portion 166 extends from the lower flange 159 to part of the bottom wall 157. The unquenched portions 164, 165, 166 extends only in the portion of the elongated body 152 through which the bulk body 153 extends.

The unquenched portions 165, 166 extend in areas where the elongate body 152 tend to be strained significantly in the event of a collision, and cover the welding spots 162, 163 (see FIGS. 20 and 21), respectively. The unquenched portion 164 cover the welding spot 161 (see FIGS. 20 and 21). Since the unquenched portions 164, 165, 166 include the welding spots 161, 162, 163, HAZ fracture at the welding spots 162, 163 is prevented.

The unquenched portions 164, 165, 166 of the elongated body 152 are low-strength portions that are softer and lower in tensile strength as they have not been quenched. All other portions of the elongated body 152 are high-strength portions that are harder and higher in tensile strength as they have been quenched.

The cross section of the elongated body 152 shown in FIG. 21 is open on the rear side 154 and uniform along the length of the elongated body 152.

As described above, the fourth embodiment includes a bulk body 153 placed in the cross section of the elongated body 152 and arc-welded to the unquenched portions 164, 165, 166 of the elongated body 152 so that the cross-sectional strength of the elongated body 152 shown in FIG. 20 is equalized to the cross-sectional strength the elongated body 152 would have if the entire elongated body 152 has been quenched.

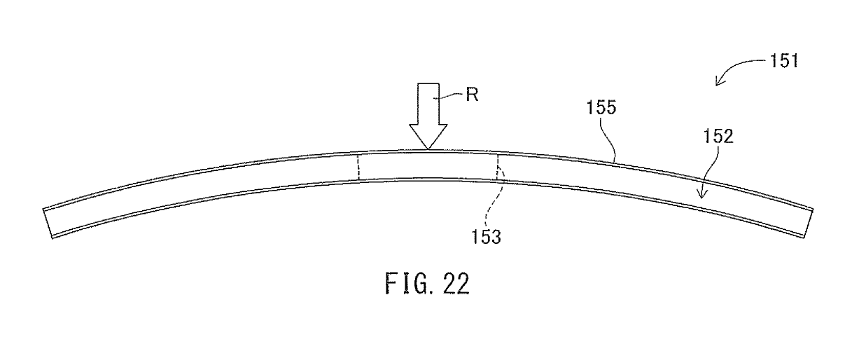

Accordingly, when an impact load R is applied to the front wall 155 of the elongated body 152 around the middle of the length of the elongated body 152 as shown in FIG. 22, the bumper reinforcement 151 in the fourth embodiment does not allow the unquenched portions 164, 165, 166 (see FIG. 21) of the elongated body 152 to be plastically deformed prior to the quenched portions of the elongated body 152. This may prevent cracks and a reduced peak load in the event of a collision.

In the bumper reinforcement 151 in the fourth embodiment, the bulk body 153 in the elongated body 152 may extend the entire length of the elongated body 152. In this case, the unquenched portions 164, 165, 166 are formed in the elongated body 152 along the entire length of the elongated body 152, and the bulk body 153 is arc-welded to the unquenched portions 164, 165, 166 of the elongated body 152 along the entire length of the elongated body 152.

### 5. Fifth Embodiment

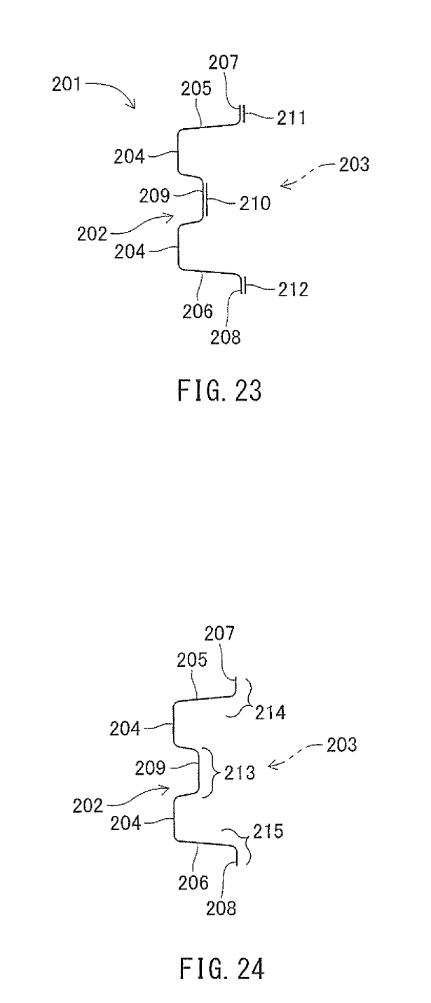

A fifth embodiment will now be described. Although the fifth embodiment will be described below by using the cross-sectional views in FIGS. 23 and 24, those features of the fifth embodiment which are substantially the same as the second embodiment will be described with reference to the figures for the second embodiment.

As in the second embodiment (see FIGS. 6 and 7), a bumper reinforcement 201 in the fifth embodiment has a curved profile and includes an elongated body 202.

The elongated body 202 is formed in advance by hot stamping a high tensile steel sheet with a tensile strength of 1,800 MPa or more.

As shown in the cross-sectional view in FIG. 23, the elongated body 202 has an open rear side 203, a front wall 204 opposite the open rear side 203, a top wall 205 extending from the upper end of the front wall 204 toward the open rear side 203, a bottom wall 206 extending from the lower end of the front wall 204 toward the open rear side 203, an upper flange 207 extending upward from the end of the top wall 205 proximate the open rear side 203, and a lower flange 208 extending downward from the end of the bottom wall 206 proximate the open rear side 203. The front wall 204 includes a bead 209 is formed along the centerline.

Carbon fiber reinforced plastic members 210, 211, 212 are coupled by insert molding to the bead 209, upper flange 207, and lower flange 208, respectively, of the elongated body 202 along the entire length of the elongated body 202. In the insert molding, the elongated body 202, which was formed in advance by hot stamping, is inserted into a mold, and then carbon fiber reinforced plastic is injected into the mold so that carbon fiber reinforced plastic members 210, 211, 212 are molded on the bead 209, upper flange 207, and lower flange 208, respectively, of the elongated body 202. The carbon fiber reinforced plastic members 210, 211, 212 are maintained at about 350° C.

As a result, the carbon fiber reinforced plastic member 210 is thus coupled to the bead 209 of the elongated body 202, the carbon fiber reinforced plastic member 211 is coupled the upper flange 207 of the elongated body 202, and the carbon fiber reinforced plastic member 212 is coupled to the lower flange 208 of the elongated body 202.

During the insert molding, the carbon fiber reinforced plastics 210, 211, 212 on the elongated body 202 are maintained at about 350° C. The elongated body 202 after the hot stamping is slowly cooled through this molding process, allowing annealing to take place so that the resultant elongated body 202 has annealed portions 213, 214, 215, as shown in FIG. 24.

Of the three annealed portions 213, 214, 215, the annealed portion 213 extends along the bead 209. The annealed portion 214 extends from the upper flange 207 to part of the top wall 205. The annealed portion 215 extends from the lower flange 208 to part of the bottom wall 206.

The annealed portions 214, 215 extend in areas where the elongate body 202 tends to be strained significantly in the event of a collision, and cover the portions of the upper and lower flanges 207, 208, respectively, on which the carbon fiber reinforced plastic members 211, 212 have been molded (see FIGS. 23 and 24).

The annealed portions 213, 214, 215 of the elongated body 202 are low-strength portions that are softer and lower in tensile strength as they have been softened in insert molding. All other portions of the elongated body 202 are high-strength portions that are harder and higher in tensile strength as they have been quenched by cooling during the insert molding after the hot stamping.

The cross section of the elongated body 202 shown in FIG. 24 is open on the rear side 203 and uniform along the length of the elongated body 202.

As described above, the fifth embodiment includes carbon fiber reinforced plastic members 210, 211, 212 molded on part of the cross section of the elongated body 202 and coupled to the annealed portions 213, 214, 215 of the elongated body 202 so that the cross-sectional strength of the bumper reinforcement 201 shown in FIG. 23 is equalized to the cross-sectional strength that the elongated body 202 would have if the entire elongated body 202 has been quenched.

Accordingly, when an impact load R is applied to the front wall 204 of the elongated body 202 around the middle of the length, the bumper reinforcement 201 in the fifth embodiment, as with the second embodiment (see FIG. 10), does not allow the annealed portions 213, 214, 215 (see FIG. 24) of the elongated body 202 to be plastically deformed prior to the quenched portions of the elongated body 202. This may prevent cracks and a reduced peak load in the event of a collision.

In the bumper reinforcement 201 in the fifth embodiment, the carbon fiber reinforced plastic members 210, 211, 212, which are coupled to the bead 209, upper flange 207, and lower flange 208, respectively, of the elongated body 202, may only extend a specified length of the elongated body 202 around the middle, which is subject to impact load R.

### 6. Other Embodiments

The present invention is not limited to the embodiments described above, and various modifications can be made without departing from the spirit and scope of the invention. For example, the first to fourth embodiments may include annealed portions instead of the unquenched portions. In this case, in the second embodiment, the elongated sheet members 60, 61, 62 may be spot-welded to the elongated body 52 after the elongated body 52 is formed by hot stamping. The fifth embodiment may include unquenched portions instead of the annealed portions.

1-6. (canceled)

7. A bumper reinforcement having a length comprising a first section and a second section, the reinforcement comprising:
a reinforcement body made of a steel sheet and having a cross section that is open on one side and uniform along the length of the bumper reinforcement, the cross section of the body in at least the first section of the reinforcement comprising a high-strength portion and a low-strength portion, the high-strength portion having a first tensile strength, and the low-strength portion having a second tensile strength that is less than the first tensile strength; and
a closure closing the open side of the body within the first section of the reinforcement and joined to the body at the low-strength portion of the body in the first section.

8. A bumper reinforcement having a length comprising a first section and a second section, the reinforcement comprising:
a reinforcement body made of a steel sheet and having a cross section that is open on one side and uniform along the length of the bumper reinforcement, the cross section of the body in at least the first section of the reinforcement comprising a high-strength portion and a low-strength portion, the high-strength portion having a first tensile strength, and the low-strength portion having a second tensile strength that is less than the first tensile strength; and
a sheet member placed on and coupled to the low-strength portion of the body within the first section.

9. A bumper reinforcement having a length comprising a first section and a second section, the reinforcement comprising:
a reinforcement body made of a steel sheet and having a cross section that is open on one side and uniform along the length of the bumper reinforcement, the cross section of the body in at least the first section of the reinforcement comprising a high-strength portion and a low-strength portion, the high-strength portion having a first tensile strength, and the low-strength portion having a second tensile strength that is less than the first tensile strength,
wherein the body in the first section of the reinforcement comprises a thicker sheet section having a first thickness and the body in the second section of the reinforcement comprises two thinner sheet sections each having a second thickness less than the first thickness, the thicker sheet section is joined between the two thinner sheet sections.

10. A bumper reinforcement having a length comprising a first section and a second section, the reinforcement comprising:
a reinforcement body made of a steel sheet and having a cross section that is open on one side and uniform along the length of the bumper reinforcement, the cross section of the body in at least the first section of the reinforcement comprising a high-strength portion and a low-strength portion, the high-strength portion having a first tensile strength, and the low-strength portion having a second tensile strength that is less than the first tensile strength; and
a bulk body placed in the reinforcement body within the first section and secured to the low-strength portion of the reinforcement body in the first section.

11. A bumper reinforcement having a length comprising a first section and a second section, the reinforcement comprising:
a reinforcement body made of a steel sheet and having a cross section that is open on one side and uniform along the length of the bumper reinforcement, the cross section of the body in at least the first section of the reinforcement comprising a high-strength portion and a low-strength portion, the high-strength portion having a first tensile strength, and the low-strength portion having a second tensile strength that is less than the first tensile strength; and
a carbon fiber reinforced plastic member placed on and coupled to the low-strength portion of the body within the first section.

12. The bumper reinforcement of claim 7, wherein a yield strength of the first section of the reinforcement is equal to a yield strength of a reinforcement body comprising the high-strength portion but no low-strength portion.

13. The bumper reinforcement of claim 7, wherein the cross section of the body in the second section comprising a high-strength portion but no low-strength portion, the high-strength portion in the second section having the first tensile strength.

14. The bumper reinforcement of claim 13, wherein a yield strength of the first section of the reinforcement is equal to a yield strength of the second section of the reinforcement.

15. The bumper reinforcement of claim 8, wherein a yield strength of the first section of the reinforcement is equal to a yield strength of a reinforcement body comprising the high-strength portion but no low-strength portion.

16. The bumper reinforcement of claim 9, wherein a yield strength of the first section of the reinforcement is equal to a yield strength of a reinforcement body comprising the high-strength portion but no low-strength portion.

17. The bumper reinforcement of claim 10, wherein a yield strength of the first section of the reinforcement is equal to a yield strength of a reinforcement body comprising the high-strength portion but no low-strength portion.

18. The bumper reinforcement of claim 11, wherein a yield strength of the first section of the reinforcement is equal to a yield strength of a reinforcement body comprising the high-strength portion but no low-strength portion.

19. The bumper reinforcement of claim 8, wherein the cross section of the body in the second section comprising a high-strength portion but no low-strength portion, the high-strength portion in the second section having the first tensile strength.

20. The bumper reinforcement of claim 9, wherein the cross section of the body in the second section comprising a high-strength portion but no low-strength portion, the high-strength portion in the second section having the first tensile strength.

21. The bumper reinforcement of claim 10, wherein the cross section of the body in the second section comprising a high-strength portion but no low-strength portion, the high-strength portion in the second section having the first tensile strength.

22. The bumper reinforcement of claim 11, wherein the cross section of the body in the second section comprising a high-strength portion but no low-strength portion, the high-strength portion in the second section having the first tensile strength.

23. The bumper reinforcement of claim 19, wherein a yield strength of the first section of the reinforcement is equal to a yield strength of the second section of the reinforcement.

24. The bumper reinforcement of claim 20, wherein a yield strength of the first section of the reinforcement is equal to a yield strength of the second section of the reinforcement.

25. The bumper reinforcement of claim 21, wherein a yield strength of the first section of the reinforcement is equal to a yield strength of the second section of the reinforcement.

26. The bumper reinforcement of claim 22, wherein a yield strength of the first section of the reinforcement is equal to a yield strength of the second section of the reinforcement.
